(19) United States
(12) Patent Application Publication
(10) Pub. No.: US 2025/0335289 A1
(43) Pub. Date: Oct. 30, 2025

(54) AUTOMATIC ISSUE IDENTIFICATION AND USER GUIDED REMEDIATION

(71) Applicant: Dell Products L.P., Round Rock, TX (US)

(72) Inventors: MANISH GIRI, Round Rock, TX (US); RHUSHABH BHANDARI, Pflugerville, TX (US); JEFFREY MORGAN LAIRSEY, Round Rock, TX (US)

(21) Appl. No.: 18/646,602

(22) Filed: Apr. 25, 2024

(51) Int. Cl. G06F 11/07

(52) U.S. Cl. CPC G06F 11/0793; G06F 11/079

(57) ABSTRACT

Methods, systems, and devices for managing a data processing system while mitigating down-time associated with addressing an identified issue of the data processing system. To manage the data processing system, an issue impacting the data processing system may be identified. Based on the identification of the issue, a dynamic resolution synthesis process may be performed to obtain at least one remediation recommendation. Based on the at least one remediation recommendation, a user guided remediation process may be performed to attempt to address the identified issue.

### FIELD

Embodiments disclosed herein relate generally to management of data processing systems. More particularly, embodiments disclosed herein relate to systems and methods for automatic and user guided management of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show data flow diagrams illustrating methods for managing a data processing system in accordance with an embodiment.

FIG. 2D shows a diagram illustrating an example graphical user interface (GUI) in accordance with an embodiment.

FIG. 3 shows a flow diagram illustrating a method for managing a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operations of data processing systems that may provide, at least in part, computer implemented services. The computer implemented services may be provided to any type and/or number of other devices and/or users of the data processing systems. Furthermore, the provided computer implemented services may be of any quantity and/or type of such services.

To provide the computer implemented services, the data processing systems may include hardware and/or software components. Operation of these hardware and/or software components may facilitate various functionalities of a data processing system, thereby causing the computer implemented services to be provided by the data processing system.

To provide specific computer implemented services, the hardware and/or software components may be configured to operate in conditions required to do so (to be referred to as “desirable conditions”, the desirable conditions being relative to a corresponding service). By configuring the hardware and/or software components to operate in the desirable conditions, functionalities of the data processing system may be facilitated in a manner conducive to providing the specific type and/or quantity of the computer implemented services. Thus, the data processing system may be placed in a desirable condition to provide such services.

However, operation of these components may change and/or a type and quantity of the computer implemented services desired by a user of the data processing system may change. If these changes occur without consideration for operating conditions, a capability of the data processing system to provide the computer implemented services as desired by the user may be limited and/or prevented entirely.

To manage operation of the data processing system, a management system in accordance with an embodiment may attempt to address issues that are, for example, impacting the data processing system, and that may prevent the desirable conditions. To do so, the management system may facilitate automatic identification of such issues impacting the data processing system, and user guided remediation of said issues.

Therefore, desirable conditions may be automatically maintained while mitigating down-time associated with addressing an identified issue of the data processing system is provided. Thus, while in the desirable conditions, the likelihood of providing the computer implemented services as desired may be increased.

In an embodiment, a method for managing a data processing system while mitigating down-time associated with addressing an identified issue of the data processing system is provided.

The method may include identifying an issue impacting the data processing system; performing, based on the identified issue, a dynamic resolution synthesis process to obtain at least one remediation recommendation; and performing, based on the at least one remediation recommendation, a user guided remediation process to attempt to address the identified issue.

Identifying the issue may include: obtaining interface data associated with an instance of a user interface presented by the data processing system; performing an analysis of the interface data based on: code rules that define when issues are being exhibited by the data processing system, the code rules being keyed to at least a portion of the interface data, and dependencies that indicate causes of the issues; and identifying, based on the analysis, the issue and at least one potential cause of the issue.

Performing the dynamic resolution synthesis process may include identifying relevant data associated with the identified issue from one or more data repositories; performing, based on the identified relevant data, at least one remediation discerning process to obtain known remediation solutions; and performing, based on the known remediation solutions, a remediation recommendation generation process to obtain the at least one remediation recommendation.

Performing the at least one remediation discerning process may include, at least in part, performing a lookup process to obtain at least a first portion of the known remediation solutions from an accessible knowledge base; performing probabilistic inferencing based on known solution-orientated action sets facilitated by the user and/or other users of the data processing system to obtain at least a second portion of the known remediation solutions; and performing a dependency matrix resolution process for identifying dependencies of the interface data based on, at least in part, code rules associated with the interface data to obtain at least a third portion of the known remediation solutions.

Performing the user guided remediation process may include: generating a user interface based on the issue and the at least one remediation recommendation; and presenting the user interface to a user to obtain user feedback from the user, the user feedback indicating a course of action for addressing the issue.

In a first instance of the presenting where the user feedback indicates that the course of action is an automated remediation: automatically performing at least one action based on the at least one recommendation, the at least one action modifying operation of the data processing system.

In a second instance of the presenting where the user feedback indicates that the course of action is a manual remediation: providing actionable steps for the user to manually address the issue using the at least one recommendation.

In a third instance of the presenting where the user feedback indicates that the course of action is to obtain alternate recommendations: performing a second dynamic resolution synthesis process to obtain an alternate remediation recommendation; and providing the alternate remediation recommendation to address the issue.

In a fourth instance of the presenting where the user feedback indicates that there is no action to be performed: marking the issue as addressed.

In an embodiment, a non-transitory media is provided. The non-transitory media may include instructions that when executed by a processor cause, at least in part, the computer-implemented method to be performed.

In an embodiment, a data processing system is provided. The data processing system may include the non-transitory media and a processor and may, at least in part, perform the method when the computer instructions are executed by the processor.

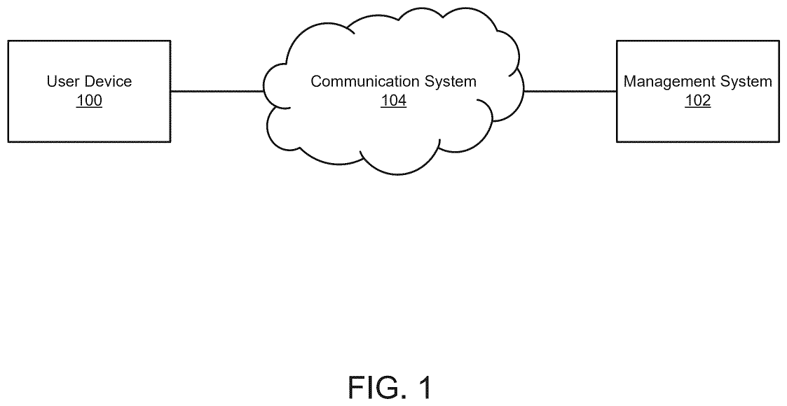

Turning to FIG. 1, a block diagram illustrating a system in accordance with an embodiment is shown. The system shown in FIG. 1 may be a distributed system that provides for management of data processing systems that may provide, at least in part, computer implemented services.

The computer implemented services may include any type and quantity of computer implemented services. The computer implemented services may include, for example, database services, data processing services, electronic communication services, and/or any other services that may be provided using one or more computing devices. The computer implemented services may be provided by, for example, user device 100, management system 102, communication system 104, and/or any other type of devices (not shown in FIG. 1).

Other types of computer implemented services may be provided by the system shown in FIG. 1 without departing from embodiments disclosed herein.

To provide the computer implemented services, the data processing systems may include hardware and/or software components. Operation of these hardware and/or software components may facilitate various functionalities of a data processing system, thereby causing the computer implemented services to be provided by the data processing system.

For example, assume a user of the data processing system requests electronic communications services from the data processing system. To provide the requested services, a hardware component of the data processing system such as a wireless communications chip may attempt to operate in a manner that facilitates wireless communications functionalities for the data processing system as requested.

To provide a specific type and/or quantity of the computer implemented services, the hardware and/or software components may be configured to operate in conditions required to do so (to be referred to as “desirable conditions”, the desirable conditions being relative to a corresponding service (e.g., the requested service)). By configuring the hardware and/or software components to operate in the desirable conditions, functionalities of the data processing system may be facilitated in a manner conducive to providing the specific type and/or quantity of the computer implemented services. Thus, the data processing system may be placed in a desirable condition to provide such services.

For example, operation of the hardware component may depend on a configuration of the hardware component, and the configuration of the hardware component may depend on a software program such as a device driver corresponding to the hardware component. Therefore, to configure the hardware component to operate in desirable conditions for providing the electronic communications services, an up-to-date version of the device driver may be required, the up-to-date version providing instruction for facilitating key functionalities (required functionalities) associated with the requested service.

However, if the hardware component is not configured to operate in the desirable conditions (e.g., the corresponding device driver is an out-of-date device driver rather than the up-to-date device driver), the data processing system may not operate in the desirable condition necessary for providing the requested service as requested by the user. Consequently, the requested service may be delayed, may be prevented entirely, and/or may otherwise not be provided in a desirable manner.

For example, an out-of-date device driver may not provide instruction necessary to facilitate key functionalities that (i) the up-to-date device driver provides, and (ii) when executed by the hardware component, may cause the data processing system to provide the requested service as requested.

In general, embodiments disclosed herein relate to systems, devices, and methods for improving the likelihood of data processing systems being able to provide desired computer implemented services. To do so, issues impacting data processing systems may be addressed using various processes. These processes may include an automatic issue identification process and a user guided remediation process. By addressing such issues using these processes, an impacted data processing system may thereby be placed in a desirable condition. Consequently, while in the desirable condition, the likelihood of providing the desired computer implemented services may be increased.

To provide the above noted functionality, the system of FIG. 1 may include user device 100, management system 102, and communication system 104. Each of which is discussed below.

User device 100 may provide, at least in part, computer implemented services. To do so, user device 100 may (i) host hardware and/or software components adapted to facilitate various functionalities of user device 100, and/or (ii) obtain requests from a user and/or other entities to provide desired computer implemented services.

However, in some cases (as previously discussed) user device 100 may not be configured to operate in a desirable condition conducive to providing the desired computer implemented services as requested. Therefore, issues impacting user device 100 (e.g., issues that cause user device 100 to operate in any condition other than the desirable condition and/or a different desirable condition also conducive to providing the desired computer implemented services) may be addressed.

Although often referred to as a singular desirable condition, it will be appreciated that the desirable condition may be one of many desirable conditions and/or may encompass information regarding any and/or all desirable conditions conducive to providing the desired computer implemented services.

To address these issues, user device 100 may perform its previously listed functionalities, as well as (iii) provide information associated with various operating states of user device 100 to, for example, management system 102, (iv) obtain one or more recommendations regarding possible modification of a current operating state of user device 100, for example, from management system 102, (v) provide the one or more recommendations to the user and/or other entities, (vi) facilitate, at least in part, user guided remediation based on the one or more recommendations to obtain an action set determined, at least in part, by the user and/or other entities, (vii) facilitate the action set to address one or more issues impacting user device 100, and/or (viii) perform other processes that may otherwise address the issues and/or cause the desired computer implemented services to be provided.

Additionally, based on the action set, user device 100 may record user interaction during performance of the action set to obtain user interaction data. This user interaction data may be used to enhance future recommendations obtained, for example, by management system 102. For example, user device 100 may provide the user interaction data to management system 102, discussed below.

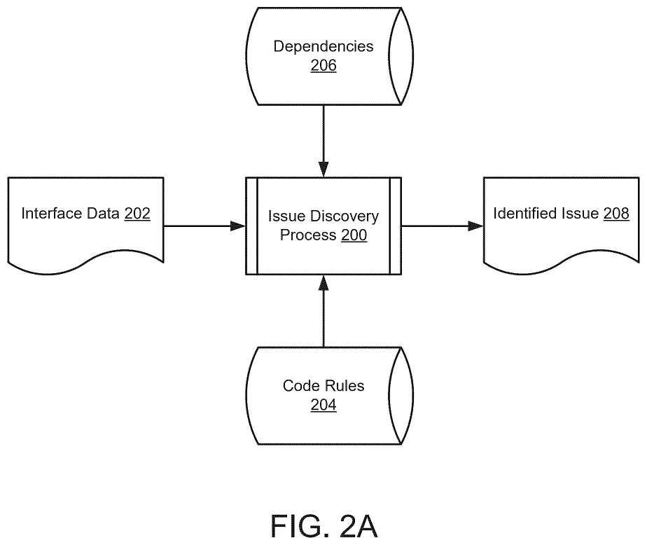

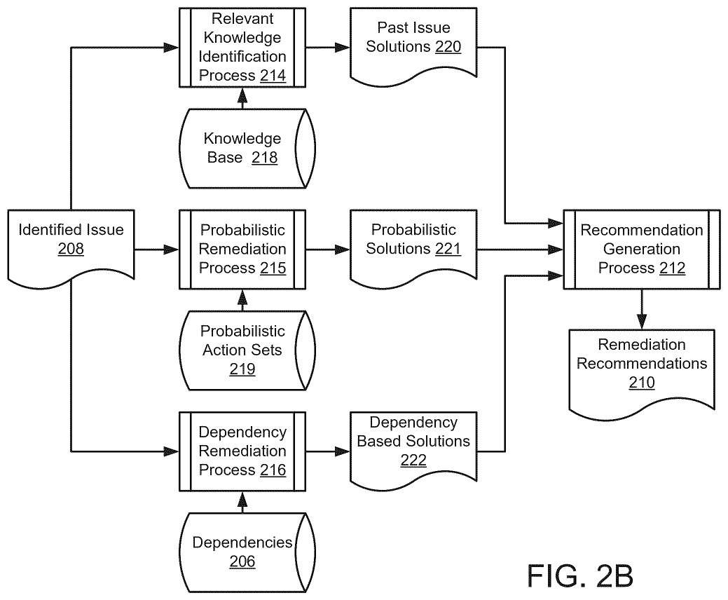

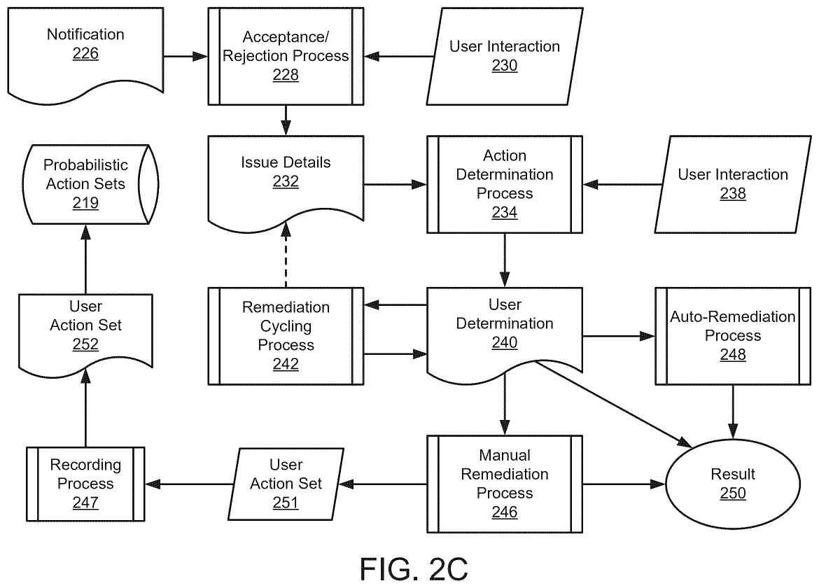

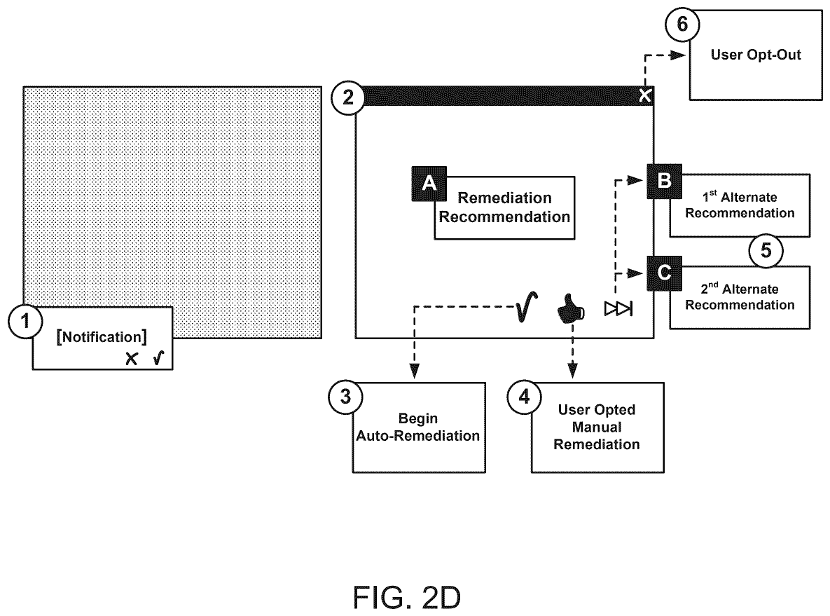

As mentioned above, management system 102 may provide functionalities that further address issues impacting user device 100 to increase the likelihood of providing the desired computer implemented services as requested. These functionalities may include (i) obtaining the information associated with various operating states of user device 100 (e.g., interface data, discussed further below and with regard to FIG. 2A), (ii) identifying an issue impacting user device 100 based on the obtained information, (iii) obtaining one or more recommendations for remediation based on the identified issue, (iv) providing the one or more recommendations to user device 100, (v) facilitating, at least in part, the user guided remediation process to obtain the user determined action set, (vi) based on the action set, obtaining user interaction data in an attempt to enhance future recommendations

It will be appreciated that the identification of issues impacting user device 100 may be performed automatically. For example, user device 100 may provide the information associated with the various operating states automatically to managements system 102, thereby automatically initiating the other aforementioned processes such as the identification of issues impacting user device 100. For additional information regarding the automatic identification of issues, refer to FIG. 2A.

For additional information regarding obtaining the one or more recommendations, refer to FIG. 2B.

For additional information regarding the user guided remediation, refer to FIGS. 2C-2D.

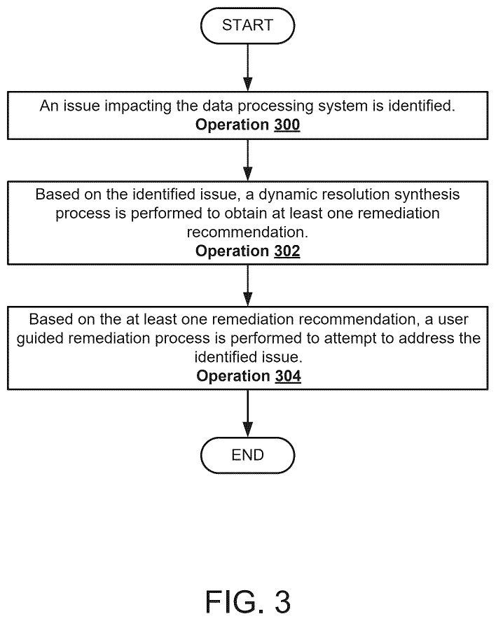

When providing their functionality, user device 100 and/or management system 102 may perform all, or a portion, of the method shown in FIG. 3.

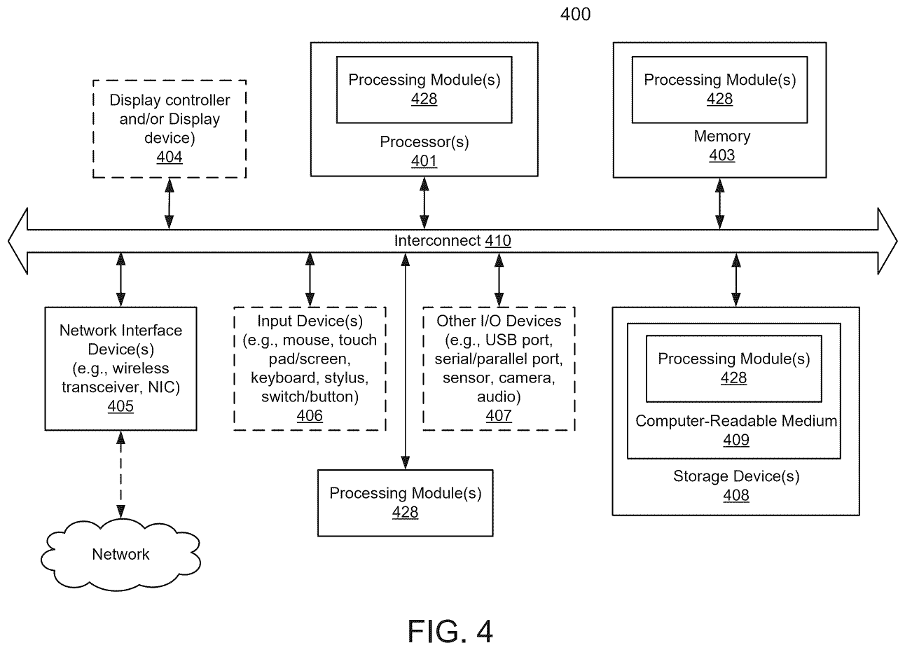

Any of (and/or components thereof) user device 100 and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 202, 208, 230, etc.) is used to represent data structures, a second set of shapes (e.g., 200, 212, etc.) is used to represent processes performed using and/or that generate data, and a third set of shapes (e.g., 204, 206, etc.) is used to represent large scale data structures such as databases.

Additionally, it will be appreciated that within the first set of shapes, a first portion (e.g., 230, 238, 251, etc.) of the first set of shapes may represent data which has yet to be obtained (e.g., and therefore, yet to be structured into a usable format) by the data processing system. A second portion of the first set of shapes (e.g., 226, 232, 240, etc.) may represent data structures in usable format. Additionally, in some cases, some of the second portion may be based on some of the first portion. For example, user determination 240 may be based on user interaction 238 in FIG. 2C, discussed further below.

Turning to FIG. 2A, a first data flow diagram in accordance with an embodiment is shown. The first data flow diagram may illustrate data used in, and data processing performed in, identifying an issue impacting a data processing system (e.g., 100).

To identify the issue, issue discovery process 200 may be performed (e.g., automatically). During issue discovery process 200, (i) interface data 202 may be ingested into issue discovery process 200 automatically based upon a user encountering an instance of a graphical user interface (GUI) displayed by the data processing system, (ii) databases (e.g., data repositories) such as code rules 204 and/or dependencies 206 may also be, at least in part, ingested into issue discovery process 200, and (iii) identified issue 208 may be outputted based on any and/or all data ingested into issue discovery process 200.

As noted above, for example, a user of the data processing system may interact with a graphical user interface (GUI) displayed by the data processing system. This data processing system may host a software application responsible for facilitating the GUI. Therefore, should the user desire interaction with the software application (and/or otherwise desire interaction with the data processing system to receive computer implemented services), the user may be required to interact with the interface. As the user interacts with the GUI, an instance of the GUI may be obtained automatically and analyzed during issue discovery process 200 to obtain, for example, a snapshot defining a state of the data processing system at the time of the interaction by the user. This state of the data processing system may determine capabilities of the data processing system (thereby determining and/or limiting possible outcomes from the interaction by the user, and thus, the computer implemented services provided).

The instance may be implemented with, for example, interface data 202 and may include (i) computer code upon which functionalities available through interaction with the GUI depend, (ii) logs indicating processes carried out and/or capable of being carried out based on the interaction, and/or (iii) other information regarding the state of the data processing system with respect to the instance.

Once ingested, interface data 202 may be subjected to any number of lookup processes (and/or other processes that may otherwise return associated data). Some of these processes may be defined by schema maintained by code rules 204 and/or dependencies 206, discussed below.

Code rules 204 may include any type and quantity of information regarding any number of topics. The topics may be similar and/or different. For example, code rules 204 may include portions of data keyed to specific issues, thereby defining the issues using respective (i) possible and/or (ii) observed outcomes indicated by interface data 202. Therefore, to obtain the keyed portions, identifiers associated with the portions of code rules 204 may be compared to information included in interface data 202. This comparison may return portions of the information corresponding with the identifiers and may thereby indicate that one or more portions of code rules 204 are keyed to the corresponding portions of the information.

For example, assume during a first instance of the GUI that a setting A appears (e.g., is displayed) as a grayed-out box, and the user may be unable to interact with the interface in any way that causes a functionality managed by setting A to be modified. In this first instance, code rules 204 may include a rule specifying that if setting A is displayed as a grayed-out box, the interface may not allow modification of setting A.

Dependencies 206, similarly, may include other portions of data keyed to the specific issues. However, rather than defining respective possible and/or observed outcomes of the issues, dependencies 206 may indicate possible causes of respective issues. For example, in this first instance, dependencies 206 may include one or more possible causes of the now identified issue (e.g., “now identified” due to being defined using code rules 204). Therefore, the one or more possible causes may include information specifying that, for example, the setting A may be displayed in a grayed-out box due to a first, third, and/or seventh configuration of the data processing system.

It will be appreciated that identifiers for code rules 204 and/or identifiers for dependencies 206 may be keyed to any number of issues, not to be limited by embodiments disclosed herein.

Thus, identified issue 208 may be obtained based on interface data 202, code rules 204, and/or dependencies 206. For example, identified issue 208 may include any number of issues to which at least a portion of code rules 204 is keyed. Additionally, any number of dependencies may be keyed to each of the any number of issues.

It will be appreciated that, in some cases, what may be identified as an issue may be different between different data processing systems. For example, in the first instance, the setting A may be grayed out, however, the functionality facilitated by setting A may be a common functionality that the data processing system is equipped to facilitate if should, for example, a dependency be addressed to remediate the issue associated with setting A.

Alternatively, assume in a second instance that a setting B is grayed-out due to a dependency on functionalities provided by hardware components that are not yet installed on the data processing system. Therefore, for example, a remediation recommendation cannot be offered that does not include recommending purchase (and/or acquirement through other means) and/or installation of the hardware components to facilitate operable connection between the hardware components and the rest of the data processing system (thereby addressing the issue based on the dependency).

Additionally, it will be appreciated, based on the second instance and should the user attempt to modify setting B, that the attempt by the user to modify setting B (despite absence of the hardware components), may initiate an identification of an issue that may or may not be automatically marked as resolved. Alternatively, in such cases as that of the second instance, no issue may be identified and/or the issue may proceed with remediation recommendations that include, for example, the acquirement and/or the installation of the hardware components.

Thus, using the data flow shown in FIG. 2A, an issue impacting a data processing system (e.g., 100) may be identified. By identifying one or more issues impacting the data processing system, at least one remediation recommendation may be obtained for user guided remediation of the data processing system and may be subsequently provided to the user for addressing the identified issue. For additional information regarding the obtaining of the at least one remediation recommendation, refer to FIG. 2B. For additional information regarding the user guided remediation process, refer to FIG. 2C. For additional information regarding the GUI, refer to FIG. 2D.

Turning to FIG. 2B, a second data flow diagram in accordance with an embodiment is shown. The second data flow diagram may illustrate data used in, and data processing performed in, obtaining at least one remediation recommendation (e.g., remediation recommendations 210).

To obtain remediation recommendations 210, for example, recommendation generation process 212 may be performed. For example, recommendation generation process 212 may be implemented by an inference model (e.g., a machine learning algorithm) that has been trained to output a prioritized remediation recommendation associated with a highest efficiency (e.g., the highest efficiency being associated with a highest increase in likelihood of resolving identified issue 208 when compared to other provided methods included in known remediation solutions, discussed below) for addressing an issue impacting a data processing system. Additionally, it will be appreciated that the highest efficiency may indicate a method in which a likelihood of addressing the identified issue to a satisfaction of a user of said data processing system is at a maximum consistency among all users of data processing systems.

During recommendation generation process 212, (i) known remediation solutions may be obtained that have been used on data processing systems to address past occurrences of identified issue 208 (discussed with regard to FIG. 2A), (ii) these known remediation solutions may be ingested into recommendation generation process 212, and based on this ingestion, (iii) recommendation generation process 212 may output remediation recommendations 210.

For example, recommendation generation process 212 may be implemented by an inference model that has been trained to output prioritized remediation recommendations whose prioritization is associated with the highest efficiency for addressing an issue impacting a data processing system.

These known remediation solutions may include, for example, (i) past issue solutions 220, (ii) probabilistic solutions 221, (iii) dependency-based solutions 222, and/or (iv) other known remediation solutions not to be limited by embodiments disclosed herein. Each of these known remediation solutions are discussed below.

Past issue solutions 220 may be, for example, a first portion of the known remediation solutions that may include portions of data from knowledge base 218 that are associated with identified issue 208. For example, the first portion may include portions of books, articles, forums, etc. regarding possible solutions to address a possible issue (e.g., identified issue 208) that has impacted data processing systems in the past.

To obtain past issue solutions 220, relevant knowledge identification process 214 may be performed. During relevant knowledge identification process 214, for example, a lookup process may be performed. During the lookup process, for example, an identifier associated with identified issue 208 may be compared to the data stored in knowledge base 218 (e.g., an article stored in knowledge base 218). If the identifier associated with the identified issue matches with information included in the stored article, this comparison may return past issue solutions 220 that includes, at least in part, a first portion of data relevant to identified issue 208 (e.g., the relevant data). This first portion of the relevant data may thereby include the matching information from the stored article.

For example, and to continue the first instance example (discussed in FIG. 2A), the grayed-out box around the setting A may have been encountered by other users of other data processing systems that display similar interfaces. For example, a user B from the other users may have encountered the grayed-out box around the setting A. Assume that user B was able to remediate the issue without depending on any feedback from a support entity. Based on user B's success, user B may get on a computing forum to share the solution found by user B. Therefore, as time continues on, user B's solution may remain, for example, publicly accessible, and eventually be included in past issue solutions 220.

Probabilistic solutions 221 may be, for example, a second portion of the known remediation solutions that may include portions of data from probabilistic action sets 219 that are associated with identified issue 208. For example, probabilistic action sets 219 may include a conglomerate of lists that define various action sets (e.g., performed by users of data processing systems) of various specificalities that when performed are allegedly able to address a possible issue (e.g., identified issue 208) that has impacted data processing systems in the past.

To obtain probabilistic solutions 221, probabilistic remediations process 215 may be performed. During probabilistic remediation process 215, for example, a lookup may be performed similarly to the lookup described with respect to relevant knowledge identification process 214. However, instead of the lookup returning the matching information from an article, the lookup may return at least one of the lists from the conglomerate that is linked to the identifier associated with identified issue 208.

For example, and to continue the first instance example (mentioned previously), the grayed-out box around the setting A may have been encountered by other users of other data processing systems that display similar interfaces. For example, a user C from the other users may have encountered the grayed-out box around the setting A. Assume that user C was able to remediate the issue by performing an action set. For example, this action set may include listed steps like (i) click the arrow labeled “setting 12” to access a drop down menu, (ii) click “option 4” from the drop down menu, (iii) press ‘crtl+c’ on your keyboard to copy option 4 to your clipboard, (iv) click on the text box labeled “setting 2” to activate the input field form for setting 2, (v) press ‘crtl+v’ on your keyboard to paste option 4 into the input field, (vi) click on the button labeled “save settings” to make these changes permanent until further changes are saved.

Based on user C's success, the action set performed by user C may be recorded and stored in probabilistic action sets 219 and linked with the identifier associated with identified issue 208. Therefore, as time continues on, user C's solution may be accessible and eventually be included in past issue solutions 220.

Dependency based solutions 222 may be, for example, a third portion of the known remediation solutions that may include portions of data from dependencies 206 that are associated with identified issue 208, discussed with regard to FIG. 2A. For example, dependencies 206 may include parameters that must be met by a data processing system to be placed in a specific operational state (e.g., the specific operational state may be the operational state in which setting A is enclosed in the grayed-out box).

To obtain dependency-based solutions 222, dependency remediation process 216 may be performed. During dependency remediation process 216, parameters that may be met to achieve an operational state in which identified issue 208 is presented may be obtained as discussed in FIG. 2A. Furthermore, the parameters may be analyzed such that a dependency associated with the highest efficiency (previously mentioned) is identified.

Therefore, using the data flow in FIG. 2B, the first portion, the second portion, the third portion and/or any other portions of the known remediation solutions may be identified and/or obtained using at least one remediation discerning process (e.g., relevant knowledge identification process 214, probabilistic remediations process 215, and/or dependency remediation process 216) to, for example, ingest identified issue 208 (e.g., the identifier). Thus, based on the ingestion of identified issue 208, respective portions of the known remediation solutions may be outputted from respective remediation discerning processes. These known remediation solutions may then be ingested into recommendation generation process 212 (discussed previously) to obtain (e.g., output) the at least one remediation recommendation (e.g., remediation recommendations 210).

Once obtained, the at least one remediation recommendation may be used in a user guided remediation process to address the identified issue impacting the data processing system. This user guided remediation process may include interactions between the user and the data processing system facilitated by a graphical user interface (GUI), as discussed with respect to FIG. 2C, below. For additional information regarding the GUI, refer to FIG. 2D.

Turning to FIG. 2C, a third data flow diagram in accordance with an embodiment is shown. The third data flow diagram may illustrate data used in, and data processing performed in, addressing an identified issue of the data processing system based on at least one remediation recommendation.

To address the identified issue (e.g., 208) of the data processing system based on the at least one remediation recommendation (e.g., 210), a user guided remediation process may be performed. During this user guided remediation process, for example, (i) a user interface (e.g., the previously mentioned GUI) may be generated based on the identified issue and the at least one remediation recommendation; and (ii) user feedback may be obtained (e.g., from the user) using the user interface to initiate processes that may be used to address the identified issue and/or modify the generated interface. By obtaining the user feedback, a data processing system may operate as determined by the user, the user being able to problem solve autonomously, thereby mitigating time that may have been spent on waiting for client support from, for example, a manufacturer of the data processing system to address the identified issue.

As shown in FIG. 2C, for example, assume usage of the data processing system (e.g., to provide computer implemented services) by the user causes generation of the user interface (e.g., the GUI). Based on this generation of the user interface, assume the processes illustrated and described with respect to FIGS. 2A-2B are performed. Consequently, by identifying an issue to obtain identified issue 208, notification 226 may be generated and conveyed to the user (e.g., using a visual display device such as a monitor operably connected to the data processing system).

Notification 226 may be implemented, for example, with a visually displayed prompt adapted to alert the user that identified issue 208 is present. Additionally, for example, the notification 226 may feature a request for input provided by the user to determine whether the user desires to attempt to address identified issue 208. Based on this request, the user may provide input such as user interaction 230. Thus, acceptance/rejection process 228 may be performed by ingesting user interaction 230 and data regarding the issue from notification 226 to output issue details 232.

Issue details 232 may include (i) identified issue 208, (ii) the at least one remediation recommendation (e.g., 210) obtained based on the discussion of FIG. 2B, (iii) a second prompt requesting second input from the user regarding the at least one remediation recommendation.

It will be appreciated that the at least one remediation recommendation may include any number of recommendations. Consequently, if there is more than one recommendation, a prioritized recommendation may be obtained to visually display to the user as part of issue details 232. The prioritized recommendation may be prioritized because of having an increased likelihood to address identified issue 208 to a threshold consistency of user satisfaction when compared to the rest of the any number of recommendations.

Based on issue details 232, action determination process 234 may be performed. During action determination process 234, issue details 232 and user interaction 238 may be ingested in action determination process 234 to output user determination 240.

User interaction 238 may be obtained similarly to user interaction 230. However, user interaction 238 has a potential of conveying a larger number of options when compared to user interaction 230. These options possibly conveyed by user interaction 238 are discussed below with respect to user determination 240.

It will be appreciated that the user may choose to ignore the prompt and/or second prompt and/or otherwise reject the attempt at addressing identified issue 208 (e.g., causing results 250, discussed further below).

User determination 240 may include data indicative of the user's choice regarding issue details 232 (e.g., the prioritized recommendation) and based on action determination process 234. This choice made by the user may result (e.g., result 250) in a process from a group of processes being performed, the performed process being dependent on what choice the user makes.

For example, the group of processes may include (i) auto-remediation process 248, (ii) manual remediation process 246, (iii) remediation cycling process 242, (iv) inaction, and/or (v) other processes used to address issues in data processing systems. Each of these processes is discussed below.

Auto-remediation process 248 may include automatically performing at least one action (e.g., without dependance on the user to perform additional processes) based on the at least one recommendation (e.g., the prioritized recommendation), the at least one action modifying operation of the data processing system.

Manual remediation process 246 may include providing actionable steps for the user to manually address the issue using the at least one recommendation. For example, the actionable steps may be provided using the visual display.

It will be appreciated that the user interface may not always perfectly reflect actions expressed by the executable computer code on which the user interface depends. Consequently, some actionable steps may not be capable of being performed exactly as conveyed by the data processing system. For example, the actionable steps may include (i) click “option 2”, (ii) scroll down to bottom of menu, (iii) click “add option”, (iv) move cursor to third tab for “advanced settings”, (v) drag “option 2” from the left white box and drop in the right white box, and (vi) click “save”. However, various settings included in these actionable steps may differ visually depending on a type of data processing system (e.g., mobile phone, laptop computer, servers in racks, etc.), and/or other features through which may otherwise display the differing visuals. For example, the second step may not have a scrolling menu due to having a large monitor to operably connect to a laptop computer. So instead of scrolling, a user of the laptop computer may simply move a cursor over to the bottom of a menu. Additionally, for example, option 1 may not appear in the setting if using a mobile device. So instead of clicking “option 2”, the user may have to click “option 1”.

It will be appreciated that, to increase a likelihood of providing actionable steps conveyed in a manner that is accurate and performable by the user, recording process 247 may be performed. During recording process 247, actions performed by the user based on the manual remediation process (e.g., user action set 251) may be recorded and stored as user action set 252. In doing so, user action set 252 may be included in, for example, probabilistic action sets 219, and thus, may be utilized in future attempts to address the identified issue (e.g., 208) impacting data processing systems (e.g., as discussed with regard to FIG. 2B).

Remediation cycling process 242 may include obtaining alternate remediation recommendations to provide to the user. For example, to obtain the alternate remediation recommendation, (i) a second dynamic resolution synthesis process may be performed to obtain an alternate remediation recommendation, and (ii) the alternate remediation recommendation may be provided to address the identified issue.

The second dynamic resolution synthesis process may be performed in a similar manner as that of the (first) dynamic resolution synthesis process. However, this second process may leave out, for example, the prioritized remediation recommendation that has already been displayed to the user. Once the alternate remediation recommendation is provided to the user, the user may again make a decision between (but may not be limited to) auto-remediation, manual remediation, inaction, and/or additional remediation cycling.

It will be appreciated that the remediation cycling process may have any number of iterations, and thus, is illustrated as outputting issue details 232 (e.g., 232A, 232B, 232C, . . . , 232N) using a dashed arrow.

Additionally, it will be appreciated that although there may be any number of remediation recommendations provided using the display, the (first) prioritized remediation recommendation may be provided any number of times depending on (i) the number of remediation recommendations, and/or (ii) whether each of the number of remediation recommendations has already been provided to the user.

Thus, using the data flow shown in FIG. 2C, a user guided remediation process may be performed using a graphical user interface (GUI) for managing a data processing system. By doing so, an identified issue (e.g., as discussed with regard to FIGS. 2A-2B) of the data processing system may be addressed using at least one remediation recommendation while mitigating down-time associated with addressing identified issues impacting data processing systems.

It will be appreciated that result 250 may represent a state and/or an operation of the data processing system that depends on the user guided remediation process.

For additional information regarding the GUI, refer to FIG. 2D.

Turning to FIG. 2D, a diagram illustrating an example graphical user interface (GUI) in accordance with an embodiment is shown. For example, this diagram may be similar to the GUI through which identification of the issue (discussed with regard to FIG. 2A), obtaining of the at least one remediation recommendation (discussed with regard to FIG. 2B), and/or performance of the user guided remediation process (discussed with regard to FIG. 2C) may be conveyed (e.g., displayed) to the user of the data processing system and/or facilitated.

For example, as illustrated in FIG. 2D, the example GUI may include a grayed-out box (e.g., depicted using dotted infill). Assume that processes are performed as discussed with regard to FIGS. 2A-2B, resulting in an identification of an issue impacting the data processing system. Based on this identified issue (e.g., 208 in FIG. 2C), the GUI may provide a notification (e.g., 226 in FIG. 2C) for a user of the data processing system. This notification is depicted, for example, in FIG. 2D by the circled number one on the left-hand side of the page.

This notification may include, for example, (i) a check mark icon that may be clicked to further facilitate the user guided remediation process in an attempt to address the identified issue, and/or (ii) an x icon that may be clicked to end the user guided remediation process (and in some cases, resulting in the identified issue being labelled as an addressed issue. For example, by clicking either of the icons, the user provides user interaction 230 using the GUI.

Assume the user clicks on the check mark icon to further facilitate the user guided remediation recommendation. A pop-up window, depicted as a white box extending below a black top bar and positioned with the circled number two, may be displayed to the user. This pop-up window may include a remediation recommendation depicted by a boxed letter ‘A’ (e.g., obtained based on the processes discussed with regard to FIGS. 2A-2B). This recommendation A may be, for example, included in issue details 232.

As discussed with regard to FIG. 2C, action determination process 234 may be performed to decide between various options for addressing the identified issue.

For example, the white box may include (i) a check mark that when clicked initiates auto-remediation, illustrated with a circled number 3, (ii) a thumbs-up icon that when clicked initiates manual remediation, illustrated with a circled number four, and/or (iii) a skip/cycle icon that when clicked may change the remediation recommendation displayed within the white box, a first (e.g., depicted by a boxed letter ‘B’) and a second (e.g., depicted by a boxed letter ‘C’) alternate recommendation illustrated with a circled number five. For example, recommendation A may be changed to 1st alternate recommendation B after the skip/cycle icon is clicked a first time. If the skip/cycle icon is clicked a second time, 2nd alternate recommendation C may replace 1st alternate recommendation B within the white box.

Additionally, for example, the black top bar may include an x icon (e.g., the white x icon) that when clicked may to end the user guided remediation process illustrated with a circled number 6 (and in some cases, resulting in the identified issue being labelled as an addressed issue.

By clicking on, for example, the icons illustrated with the circled numbers 3-6, the user may provide user interaction 238 to the data processing system using the GUI. Thus, a graphical user interface (GUI) may be used to facilitate user guided remediation processes by prompting the user for interaction, obtaining data based on the interaction, and processing the data to determine processes to be performed. In doing so, a likelihood of addressing the identified issue to a satisfaction of the user may be improved, and therefore a likelihood of providing the computer implemented services as desired by the user may be increased.

When providing its functionality, components of user device 100, communication system 104, and/or management system 102 may perform all, or a portion, of the methods and operations illustrated in FIG. 3.

Thus, via data structures, interactions, and graphical user interface (GUI) examples as shown in FIGS. 2A-2D, management system 102 (shown and discussed with regard to FIG. 1), and/or other entities not explicitly shown in FIG. 1, may manage data processing systems (e.g., user device 100, also shown in FIG. 1) to increase the likelihood of providing desired computer implemented services while mitigating down-time associated with addressing identified issues of the data processing systems. This down-time may be mitigated by identifying an issue impacting a data processing system, performing a dynamic resolution synthesis process based on the identified issue to obtain at least one remediation recommendation, and performing a user guided remediation process based on the at least one remediation recommendation to attempt to address the identified issue.

While illustrated in FIGS. 2A-2D with a limited number of specific components, a system may include additional, fewer, and/or different components without departing from embodiments disclosed herein.

As discussed above, the components of FIG. 1 may perform various methods to manage data processing systems (e.g., while mitigating the previously discussed down-time). FIG. 3 illustrates methods that may be performed by the components of FIG. 1-2D.

In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing a data processing system in accordance with an embodiment is shown. The method may be performed, for example, by a management system (e.g., 102) and/or any other entity.

At operation 300, an issue impacting the data processing system is identified. The issue may be identified by obtaining interface data associated with an instance of a user interface (e.g., the GUI) presented by the data processing system, and/or performing an analysis of the interface data based on (i) code rules that define when issues are being exhibited by the data processing system, the code rules being keyed to at least a portion of the interface data, and (ii) dependencies that may be capable of causing the issues.

To obtain the interface data, the management system, for example, may (i) receive the interface data via communication transmissions from another device (e.g., the data processing system), (ii) retrieve the interface data from local storage of the data processing system, (iii) generate the interface data based on the instance of the user interface, and/or (iv) obtain the interface data via other processes.

Once obtained, and as noted above, an analysis of the interface data may be performed based on the code rules and the dependencies. For example, any possible issues impacting the data processing system may be included in the interface data and may be defined by the code rules, as discussed with respect to FIG. 2A. The dependencies may define operating states that may be responsible for the any possible issues defined by the code rules.

Additionally, it will be appreciated that some issues may be, for example, unprecedented. It will be appreciated, however, that if an unprecedented issue exists within an instance, then a user may (using various processes not to be limiting to embodiments discussed herein) label the unprecedented issue as an issue to be addressed by, for example, the management system. For example, the user may interact with the user interface (e.g., graphical user interface (GUI)) presented by the data processing system to facilitate the various processes to label an issue as needing to be addressed.

For additional information regarding the code rules and/or the dependencies, refer back to FIG. 2A.

Thus, based on the analysis, the issue and at least one potential cause of the issue may be identified to obtain the identified issue.

At operation 302, a dynamic resolution synthesis process is performed based on the identified issue to obtain at least one remediation recommendation. The dynamic resolution synthesis process may be performed by (i) identifying relevant data associated with the identified issue from one or more data repositories, (ii) performing, based on the identified relevant data, at least one remediation discerning process to obtain known remediation solutions, and/or (iii) performing, based on the known remediation solutions, a remediation recommendation generation process to obtain the at least one remediation recommendation.

To identify the relevant data associated with the identified issue, the identifier associated with the identified issue may also be associated with portions of data from the data repositories. This identifier may be obtained, for example, as part of instance data 202 and/or may be generated by the management system and/or the data processing system.

It will be appreciated that the obtaining of the identifier may be performed as a sub-process of operation 300, 302, and/or other operations. For example, this sub-process may be obtained as part of obtaining interface data 202 in FIG. 2A and/or identified issue 208 in FIGS. 2A-2B.

Using the identifier, the relevant data (data associated with the identified issue) stored in a repository may be identified. However, further processes may be performed to discern past known solutions from irrelevant data and/or data whose efficiency may be outside an acceptable threshold for efficiency. These further processes may be referred to as “at least one remediation discerning process”.

For example these remediation discerning processes may include (i) performing a lookup process to obtain at least a first portion of the known remediation solutions from an accessible knowledge base, (ii) performing probabilistic inferencing based on the known solution-oriented action sets facilitated by the user and/or other users of the data processing system to obtain at least a second portion of the known remediation solutions, (iii) performing a dependency matrix resolution process for identifying dependencies of the interface data based on, at least in part, code rules associated with the interface data to obtain at least a third portion of the known remediation solutions, and/or (iv) performing other processes (not to be limited to embodiments herein) to obtain other portions of the known remediation solutions.

For example, the accessible knowledge base may have books, articles, blogs, etc. regarding various issues that may impact a data processing system. To obtain the first portion, the lookup may be performed using the identifier, the lookup returning portions of the knowledge base associated with the identifier (and thus, the identified issue).

Additionally, the at least one remediation discerning process may be, at least in part, facilitated using an inference model trained to perform, for example, the probabilistic inferencing. This probabilistic inferencing may be based on action sets performed by the user and/or the other users, as mentioned above. The action sets may define specific interactions, manipulations, etc. facilitated by the user and/or the other users to achieve a particular purpose. These actions sets and their respective particular purposes may then be recorded and stored for future reference and/or otherwise future utilization. How one or more actions sets associated with the identified issue may be identified and/or otherwise obtained, may be based on, for example, being keyed to the previously mentioned identifier.

Additionally, for example, the dependency matrix resolution process may be performed in a similar manner as to how the dependencies are identified and/or otherwise obtained with regard to operation 300 (e.g., finding the cause of an issue present during the instance. However, this dependency matrix resolution process may further include making a determination (e.g., and/or otherwise inferring, such as with another inference model) regarding which dependency is a solution that meets the acceptable threshold for efficiency.

For additional information regarding the remediation discerning processes, refer back to FIG. 2B.

At operation 304, a user guided remediation process is performed based on the at least one remediation recommendation to attempt to address the identified issue. The user guided remediation process may be performed by (i) generating a user interface based on the (identified) issue and the at least one remediation recommendation, and/or (ii) presenting the user interface to a user to obtain user feedback from the user, the user feedback indicating a course of action for addressing the issue.

It will be appreciated that each time the user interface and/or interactable GUI is generated, a new instance of a same and/or a different instance of an interface (e.g., along with corresponding interface data) may be presented, for example, by the data processing system.

By generating the user interface based on the identified issue, the user, for example, may be made aware of the identified issue. Additionally, based on the user feedback obtained during the user guided remediation process, the user may be allowed autonomy regarding the user's device actions when choosing how (if at all) to address the identified issue.

How the identified issue may be addressed may be based on a type of course of action determined by the user by providing the user feedback via the generated user interface.

For additional information regarding the user feedback, refer back to FIG. 2C.

These types (of courses of action) may include (i) an automated remediation, (ii) a manual remediation, (iii) obtaining of alternative recommendations to either automatically and/or manually address, (iv) not performing an action to address the issue, and/or (v) other types of remediations.

Thus, these courses of action may result in the data processing system and/or the management system defining the identified issue as having been addressed to a satisfaction of the user. For example, the automated remediation may include automatically performing at least one action based on the at least one recommendation, the at least one action modifying operation of the data processing system. The manual remediation may include providing actionable steps for the user to manually address the issue using the at least one recommendation. The obtaining of alternate recommendations may include performing a second dynamic resolution synthesis process to obtain an alternate remediation recommendation and providing the alternate remediation recommendation to address the issue, which may then be subject to the automatic and/or manual remediation processes.

The method may end following operation 304.

Thus, using the method illustrated in FIG. 3, embodiments disclosed herein may manage data processing systems to increase a likelihood of providing desired computer implemented services while mitigating down-time associated with addressing identified issues of the data processing systems. For example, by automatically identifying a possible issue impacting a data processing system that a user of the data processing system may encounter, and automatically facilitating various processes to obtain remediation recommendations that a user may choose from; time (e.g., down-time) generally spent (i) submitting help tickets (and/or otherwise contacting support to address the possible issue) and (ii) waiting for the support to provide a possible solution, may be mitigated. This mitigation of down-time may provide a user of the data processing system with additional time to use as the user sees fit. Additionally, by facilitating the user guided remediation process, the method illustrated in FIG. 3 may provide the user with an autonomy over control of processes for managing the data processing system.

Any of the processes and/or components illustrated in and/or discussed with regard to FIGS. 1-3 may be implemented with and/or used in conjunction with one or more computing devices. For example, the user guided remediation process may be implemented using an interactable graphical user interface (GUI). Various devices may be used to interact with the GUI via operable connection to the data processing system, and the GUI may be managed by one or more software applications that may, at least in part, be hosted by the data processing system.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system while mitigating down-time associated with addressing an identified issue of the data processing system, the method comprising:
identifying an issue impacting the data processing system;
performing, based on the identified issue, a dynamic resolution synthesis process to obtain at least one remediation recommendation; and
performing, based on the at least one remediation recommendation, a user guided remediation process to attempt to address the identified issue.

2. The method of claim 1, wherein identifying the issue comprises:
obtaining interface data associated with an instance of a user interface presented by the data processing system;
performing an analysis of the interface data based on:
code rules that define when issues are being exhibited by the data processing system, the code rules being keyed to at least a portion of the interface data, and
dependencies that indicate causes of the issues; and
identifying, based on the analysis, the issue and at least one potential cause of the issue.

3. The method of claim 2, wherein performing the dynamic resolution synthesis process comprises:
identifying relevant data associated with the identified issue from one or more data repositories;
performing, based on the identified relevant data, at least one remediation discerning process to obtain known remediation solutions; and
performing, based on the known remediation solutions, a remediation recommendation generation process to obtain the at least one remediation recommendation.

4. The method of claim 3, wherein performing the at least one remediation discerning process comprises, at least in part,
performing a lookup process to obtain at least a first portion of the known remediation solutions from an accessible knowledge base;
performing probabilistic inferencing based on known solution-orientated action sets facilitated by a user and/or other users of the data processing system to obtain at least a second portion of the known remediation solutions; and
performing a dependency matrix resolution process for identifying dependencies of the interface data based on, at least in part, code rules associated with the interface data to obtain at least a third portion of the known remediation solutions.

5. The method of claim 1, wherein performing the user guided remediation process comprises:
generating a user interface based on the issue and the at least one remediation recommendation; and
presenting the user interface to a user to obtain user feedback from the user, the user feedback indicating a course of action for addressing the issue.

6. The method of claim 5, wherein in a first instance of the presenting where the user feedback indicates that the course of action is an automated remediation:
automatically performing at least one action based on the at least one remediation recommendation, the at least one action modifying operation of the data processing system.

7. The method of claim 6, wherein in a second instance of the presenting where the user feedback indicates that the course of action is a manual remediation:
providing actionable steps for the user to manually address the issue using the at least one remediation recommendation.

8. The method of claim 7, wherein based on the performance of the actionable steps by the user, actual actions of the user relative to the data processing system are recorded and used to update the dynamic resolution synthesis process so that future dynamic resolution synthesis processes are more likely to align with user selected processes.

9. The method of claim 7, wherein in a third instance of the presenting where the user feedback indicates that the course of action is to obtain alternate recommendations:
performing a second dynamic resolution synthesis process to obtain an alternate remediation recommendation; and
providing the alternate remediation recommendation to address the issue.

10. The method of claim 9, wherein in a fourth instance of the presenting where the user feedback indicates that there is no action to be performed:
marking the issue as addressed.

11. The method of claim 1, wherein performing the dynamic resolution synthesis process comprises integrating data and user interactions across a cloud aggregate system infrastructure, the integrated data and integrated user interaction being obtained from devices and their device components of the cloud aggregate system infrastructure.

12. The A non-transitory machine-readable medium having instructions stored therein, which when executed by a processor, cause the processor to perform operations for managing a data processing system while mitigating down-time associated with addressing an identified issue of the data processing system, the operations comprising:
identifying an issue impacting the data processing system;
performing, based on the identified issue, a dynamic resolution synthesis process to obtain at least one remediation recommendation; and
performing, based on the at least one remediation recommendation, a user guided remediation process to attempt to address the identified issue.

13. The non-transitory machine-readable medium of claim 12, wherein identifying the issue comprises:
obtaining interface data associated with an instance of a user interface presented by the data processing system;
performing an analysis of the interface data based on:
code rules that define when issues are being exhibited by the data processing system, the code rules being keyed to at least a portion of the interface data, and
dependencies that indicate causes of the issues; and
identifying, based on the analysis, the issue and at least one potential cause of the issue.

14. The non-transitory machine-readable medium of claim 13, wherein performing the dynamic resolution synthesis process comprises:
identifying relevant data associated with the identified issue from one or more data repositories;
performing, based on the identified relevant data, at least one remediation discerning process to obtain known remediation solutions; and
performing, based on the known remediation solutions, a remediation recommendation generation process to obtain the at least one remediation recommendation.

15. The non-transitory machine-readable medium of claim 14, wherein performing the at least one remediation discerning process comprises, at least in part,
performing a lookup process to obtain at least a first portion of the known remediation solutions from an accessible knowledge base;
performing probabilistic inferencing based on known solution-orientated action sets facilitated by a user and/or other users of the data processing system to obtain at least a second portion of the known remediation solutions; and
performing a dependency matrix resolution process for identifying dependencies of the interface data based on, at least in part, code rules associated with the interface data to obtain at least a third portion of the known remediation solutions.

16. The non-transitory machine-readable medium of claim 12, wherein performing the user guided remediation process comprises:
generating a user interface based on the issue and the at least one remediation recommendation; and
presenting the user interface to a user to obtain user feedback from the user, the user feedback indicating a course of action for addressing the issue.

17. A system, comprising:
a processor; and
a memory coupled to the processor to store instructions, which when executed by the processor, cause the processor to perform operations for managing a data processing system while mitigating down-time associated with addressing an identified issue of the data processing system, the operations comprising:
identifying an issue impacting the data processing system;
performing, based on the identified issue, a dynamic resolution synthesis process to obtain at least one remediation recommendation; and
performing, based on the at least one remediation recommendation, a user guided remediation process to attempt to address the identified issue.

18. The system of claim 17, wherein identifying the issue comprises:
obtaining interface data associated with an instance of a user interface presented by the data processing system;
performing an analysis of the interface data based on:
code rules that define when issues are being exhibited by the data processing system, the code rules being keyed to at least a portion of the interface data, and
dependencies that indicate causes of the issues; and
identifying, based on the analysis, the issue and at least one potential cause of the issue.

19. The system of claim 18, wherein performing the dynamic resolution synthesis process comprises:
identifying relevant data associated with the identified issue from one or more data repositories;
performing, based on the identified relevant data, at least one remediation discerning process to obtain known remediation solutions; and
performing, based on the known remediation solutions, a remediation recommendation generation process to obtain the at least one remediation recommendation.

20. The system of claim 19, wherein performing the at least one remediation discerning process comprises, at least in part,
performing a lookup process to obtain at least a first portion of the known remediation solutions from an accessible knowledge base;
performing probabilistic inferencing based on known solution-orientated action sets facilitated by a user and/or other users of the data processing system to obtain at least a second portion of the known remediation solutions; and
performing a dependency matrix resolution process for identifying dependencies of the interface data based on, at least in part, code rules associated with the interface data to obtain at least a third portion of the known remediation solutions.
